(19) United States
(12) Patent Application Publication
(10) Pub. No.: US 2006/0006262 A1
(43) Pub. Date: Jan. 12, 2006

(54) Interchangeable spice grinding assembly

(76) Inventor: Hans P.J. Gilberts, Den Dolder (NL)

Correspondence Address: VEDDER PRICE KAUFMAN & KAMMHOLZ, 222 N. LASALLE STREET, CHICAGO, IL, 60601, US

(21) Appl. No.: 10/889,499

(22) Filed: Jul. 12, 2004

(51) Int. Cl. A47J 42/00

(52) U.S. Cl. 241/169.1

(57) ABSTRACT

A spice grinding assembly includes a spice container having a spice holding portion and a dispensing portion, wherein the dispensing portion guides the spice to a mill guide. The mill guide grinding the spice to generate spice grounds. The spice grinding assembly includes a central pole extending up from the base member through a central aperture of the spice container. A top affixes to the central pole and engages the spice container. Rotation of the top rotates the central pole, which thereupon rotates the mill guide. When the top is attached to the central pole, the spice container is fitted between the top and the bottom portion and spice balls flow through the dispensing portion to the mill guide such that rotation of the mill guide generates spice grounds.

### BACKGROUND

The present invention relates generally to spice and other seasoning assemblies and more specifically to multiple containers having multiple spices and seasoning in an interchangeable grinding system.

With specific seasonings, such as spices or peppers, freshness is paramount. Freshness may be achieved by physically grinding pepper ball or other seasoning balls prior to consumption. A common approach is a standard pepper grinder having a central cavity that stores the spice. In the common pepper grinder, the bottom portion includes a grinding assembly, typically including a mill, that acts to grind up the seasoning.

As the bottom portion is rotated, the mill in the bottom portion also rotates, crushing the balls of spice and creating grounds. These common spice grinders, as commonly referred to also as pepper grinders, include grooved sections for griping the bottom portion.

Another common feature is a removable top portion. The top portion is removed, exposing the central cavity. Upon removal of the top portion, the spice grinder may be refilled with more spice balls or may be stocked with a different spice.

The current spice grinders have several specific limitations relating to the quality of ground spices. One problem that arises is the freshness of the spice balls. The central chamber of the spice grinder is not sealed, therefore any moisture may be absorbed by the spice balls. As the spice balls tend to be very absorbent and the spice grinder is typically stored in a kitchen where there is a tendency for excess moisture from cooking, the current spice grinders may not produce the freshest spice grounds.

Another common problem arises with re-using the spice grinder for a different spice. Unless the grinding assemblies, including the grinding mill and the central cavity, are properly cleaned, dust and excess grounds from previous spices may be mixed with the current spice. Therefore the grounds may contain grounds from the current spice in the spice grinder and leftover grounds from the previous spice in the container.

Another common problem arises when refilling the spice grinder. When the top portion is removed, the central cavity is exposed and spices from a storage container may be poured into the central cavity. Based on the nature of the central cavity and the dispensing unit, problems can arise with spice balls spilling outside of the spice grinder. Therefore, in filling the spice grinder, care must be taken to not spill excess spice balls. Furthermore, when a person who cooks using multiple spices, the current spice grinding techniques require the person to either purchase multiple spice grinders or continually empty and refill a single spice grinder.

Therefore, there exists a need for a spice grinding assembly that allows a user to quickly and effectively use multiple spices with a single grinding assembly, that allows for the maintenance of spice ball freshness.

### BRIEF DESCRIPTION OF THE DRAWINGS

Certain embodiments are shown in the drawings. However, it is understood that the present disclosure is not limited to the arrangements and instrumentalities shown in the attached drawings, wherein:

FIG. 1 illustrates a plan view of one embodiment of a spice grinding assembly;

FIG. 2 illustrates a cross-sectional view of the spice grinding assembly of FIG. 1;

FIG. 3 illustrates a plan view of a spice container;

FIG. 4 illustrates a plan view of the spice container of FIG. 3 being disposed on a central pole;

FIG. 5 illustrates a plan view of the rotational assembly of the spice grinding assembly;

FIG. 6 illustrates a perspective view of a dispensing cavity of the spice grinding assembly;

FIG. 7 illustrates a perspective view of a mill channel guide of the spice grinding assembly;

FIG. 8 illustrates a perspective view of a mill guide of the spice grinding assembly; and

FIG. 9 illustrates a perspective view of an interchangeable spice grinding system having multiple spice containers.

### DETAILED DESCRIPTION

For the purposes of promoting an understanding of the principles disclosed herein, reference will now be made to the preferred embodiments illustrated in the drawings and specific language will be used to describe the same. It will nevertheless be understood that no limitation of the scope is thereby intended, such alterations and further modifications in the illustrated device, and such further applications of the principles disclosed as illustrated therein being contemplated as would normally occur to one skilled in the art to which this disclosure relates.

Briefly, a spice grinding assembly includes a spice container having a spice holding portion and a dispensing cavity. The spice holding portion is a sealed self-contained portion having spice balls disposed therein. The dispensing cavity includes elements for guiding the spice balls to a mill guide. The spice grinding assembly further includes a base member including the mill guide. The mill guide includes portions for receiving the spice balls and edges for grinding the spice balls to generate spice grounds.

The spice grinding assembly includes a central pole extending up from the base member. The central pole extends through a central aperture of the spice container when the spice container contactingly engages the base member. A top is affixable to the central pole and engages the spice container. Rotation of the top rotates the central pole, which thereupon rotates the mill guide. When the top is attached to the central pole, the spice container is fitted between the top and the bottom portion and spice balls flow through the dispensing portion to the mill guide such that rotation of the mill guide generates spice grounds.

The spice grinding assembly uses one or more sealed spice containers that are interchangeable within the top portion and the bottom portion. The sealed spice containers insure the freshness of the spice balls. The interchangeable containers allow a user to remove the top, pull the spice container up over the central pole and insert a new spice container over the pole, attached the pole and generate new spice grounds. Therefore, a user may quickly interchanges spices in the spice grinding assembly without having to clean the assembly or risk commingling grounds from multiple spice balls grindings.

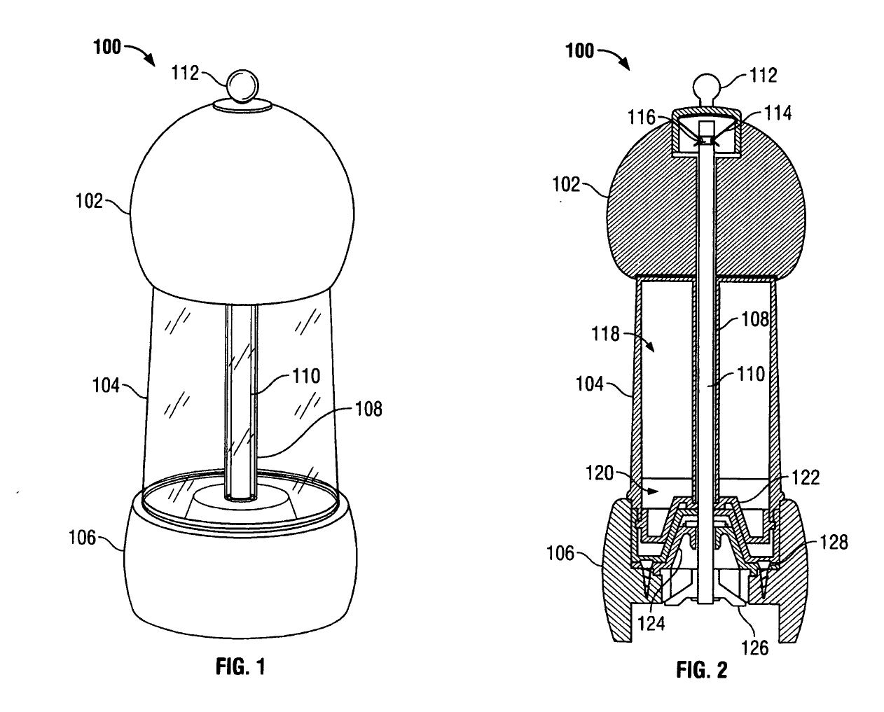

More specifically, FIG. 1 illustrates a plan view of one embodiment of a spice grinding assembly 100. The spice grinding assembly 100 includes a top portion 102, a spice container 104 and a bottom portion 106. Further, extending through a central aperture 108 of the spice container 104 is a central pole 110. As visible in FIG. 2 and discussed below, the top portion 102 is affixed to the central pole 110 to secure the spice container 104 relative to the bottom portion 106.

Illustrated in FIG. 1, the top portion 102 is generally spherical with a knob 112 at the top. Although, as recognized by one having ordinary skill in the art, any other suitable shape may be utilized such that the top portion 102 affixes to the central pole 110 and allows for rotational displacement of the top portion 102 about a central axis of the pole 110. For example, one embodiment may include dimples, raised edges or annular grooves disposed on the top portion for improved gripping of the top portion.

FIG. 2 illustrates a cross section of the spice grinding assembly 100. The assembly 100 includes the top portion 102, the spice container 104, the bottom portion 106, the central pole 110 disposed in the central aperture 108 of the spice container 104 and the knob 112. Further illustrated in the cross-section of FIG. 2, the top portion 102 includes an engagement means 114 interiorly disposed within the top portion 102. In one embodiment, the engagement means 114 is a fitting member that snap fits onto the central pole 110.

Also, the central pole 110 includes a notched edge 116 engaged by the engagement means 114. In this embodiment, the notched edge 116 operates in combination with the engagement means 114 to secure the top 102 to the central pole 110. As recognized by one having ordinary skill in the art, any other suitable engagement means 114 and notched edge 116 may be utilized to affix the top portion 102 to the central pole 110 such that the top portion 102 may be quickly attached and readily removed from contacting engagement.

The spice container 104 further includes a spice holding portion 118 and a dispensing portion 120. The spice holding portion 118 is disposed above the dispensing portion 120 such that spice balls disposed within the spice holding portion 118 are gravity-fed into the dispensing portion 120.

The dispensing portion 120 includes a mill guide channel 122 disposed therein. The mill guide channel 122 has several apertures (not visible) that, when properly aligned with apertures (not visible) within the dispensing portion 120, allow for the flow of the spice balls into a mill guide channel 124. FIG. 2 further illustrates a ground dispensing portion 126 such that the grounds, when generated by the mill guide 124, pass through the dispensing portion 126. In one embodiment, the dispensing portion 126 is attached to the bottom portion 108 using fasteners 128.

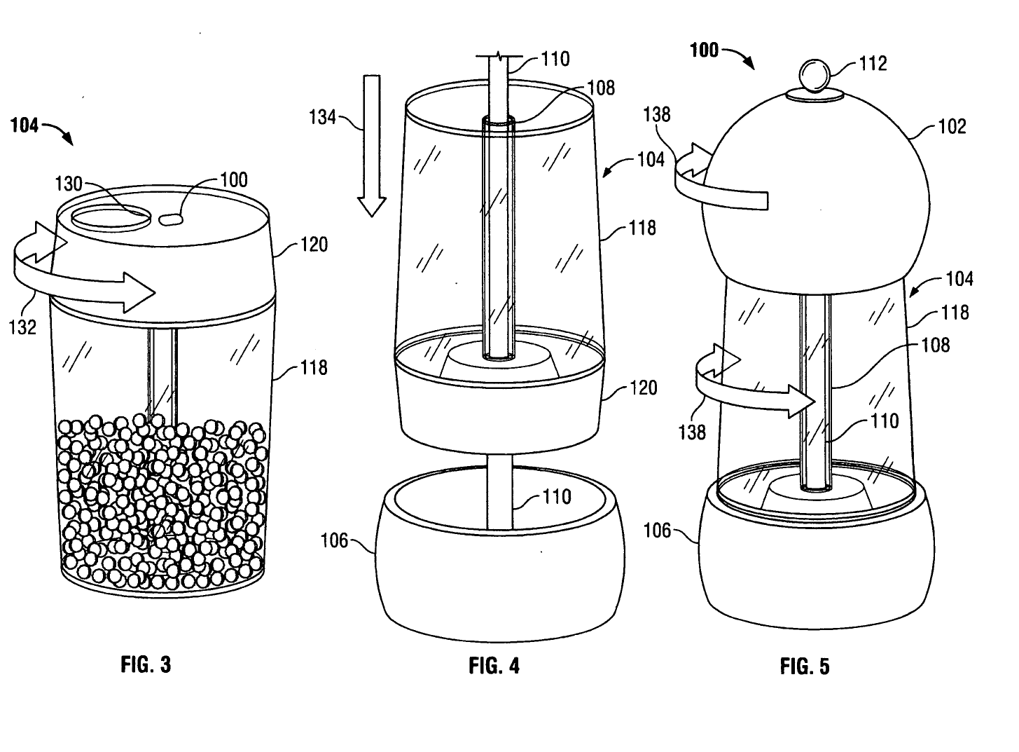

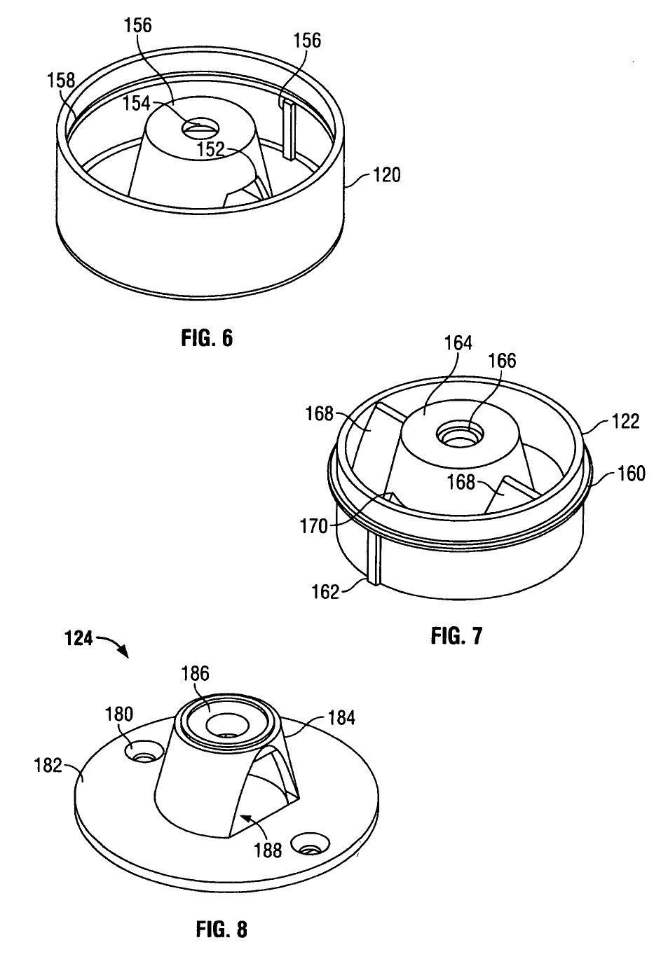

FIG. 3 illustrates a plan view of the spice container 104. The container 104 includes the spice holding portion 118 and the dispensing portion 120. The central aperture 108 extends through the center of the container 104. The container 104 is in a storage position wherein the spice holding portion 118 is below the dispensing portion 120. In one embodiment, the dispensing portion 120 includes a dispensing aperture 130 and is rotatable about the central axis to allow for freshness of the spice balls stored therein. Based on the orientation of apertures, as discussed further below with regards to FIGS. 6-8, the dispensing portion 120 is rotated in a direction 132 to either open or close the dispensing aperture 130, relative to the mill guide in the bottom portion 106.

FIG. 4 illustrates a plan view of the application of the insertion of the spice container 104 into contacting engagement with the bottom portion 106 about the central pole 110. In the installation of the spice container 104, the container is inserted in a direction 134 until the dispensing cavity 120 is in a snug-fitting relation to the bottom portion 106. Moreover, when installed about the central pole 110, the spice holding portion 118 is above the dispensing portion 120.

FIG. 5 illustrates the spice grinding assembly 100 fully assembled. The top portion 102, including in one embodiment the knob 112, secures the spice container 104 relative to the bottom portion 106 about the central pole 108 extending through the central aperture 108. The spice holding portion 118 is exposed and may rotated in the direction 136. Rotating the spice holding portion 118 to the right aligns apertures 130 within the dispensing portion (not visible), as discussed below with respect to FIGS. 6-8. Therefore, prior to rotation 136, the container 104 is sealed. To re-seal the container 104, the spice holding portion 118 is rotated 136 to the left.

When the dispensing portion is open, based on the rotation 136, the top portion 102 may then be rotated in the direction 138. The rotation 138 of the top portion 102 thereby causes the rotation of the central pole 110 within the central aperture 108. The rotation of the pole 110 rotates the mill guide (not visible) within the bottom portion 106, thereby grinding the spice balls to generate spice grounds.

FIG. 6 illustrates a perspective view of one embodiment of the dispensing portion 120. The dispensing portion 120 includes an interior raised section 150 having apertures 152 (only one visible) on opposing sides of the raised section 150. Within the raised section 150 is a central hole 154 through which the pole (110 of FIGS. 1-5) extends. Further within the dispensing portion 120 are stops 156 disposed the base of the dispensing cavity 150 and a ridge 158. As discussed further with respect to FIG. 7, the stops 156 and ridge 158 allow for sealing and opening of the dispensing cavity 120.

FIG. 7 illustrates a perspective view of one embodiment of the mill guide channel 122. The mill guide channel 122 includes an outer ridge 160 and a multiple stops 162 (only one visible). The mill guide channel 122 is disposed within dispensing portion 120 upon assembly. The raised section 150 of the dispensing portion 120 of FIG. 6 aligns with a raised section 164 of the mill guide channel 122 and the raised section 164 further includes an aperture 166 allowing for the disposition of the central pole (110 of FIGS. 1-5) therethrough.

In one embodiment, the mill guide channel 122 further includes multiple sloped surfaces 168 that guide the spice balls towards apertures 170 (only one aperture visible). The apertures 170 align with the apertures 152 within the dispensing portion of FIG. 6 when the spice container is in an open position, using the stops 156 and 162 and the guides 158 and 160, the apertures 170 and 152. Therefore, prior to installation of the spice container into the spice grinding assembly, the dispensing portion may be rotated to align the apertures 170 and 152, such as illustrated generally in FIG. 3 with arrow 132.

FIG. 8 illustrates a perspective view of a mill guide 124. The mill guide 124 is assembled in the bottom portion 106 (FIG. 1) using any suitable type of fastening means, such as fasteners extending through fastening apertures 180 disposed on a base portion 182 of the mill guide 124. The mill guide 124 further includes a raised portion 184 having a central aperture 186 disposed on top of the raised portion 184 and side dispensing apertures 188 on the sides of the raised portions 184. During assembly, the central pole extends through the central aperture 186 and the side apertures 188 align with the apertures 152 in the dispensing cavity and the apertures 170 of the mill guide channel 122.

The mill guide 124 further includes a cutting edge 190 on the side apertures 188. When spice balls flow through the mill guide channel 122, they are held in place by the dispensing portion (126 of FIG. 2) such that upon rotation of the mill guide 124, the cutting edges 190 grind the spice balls to generate spice grounds. These spice grounds then flow out through the dispensing portion.

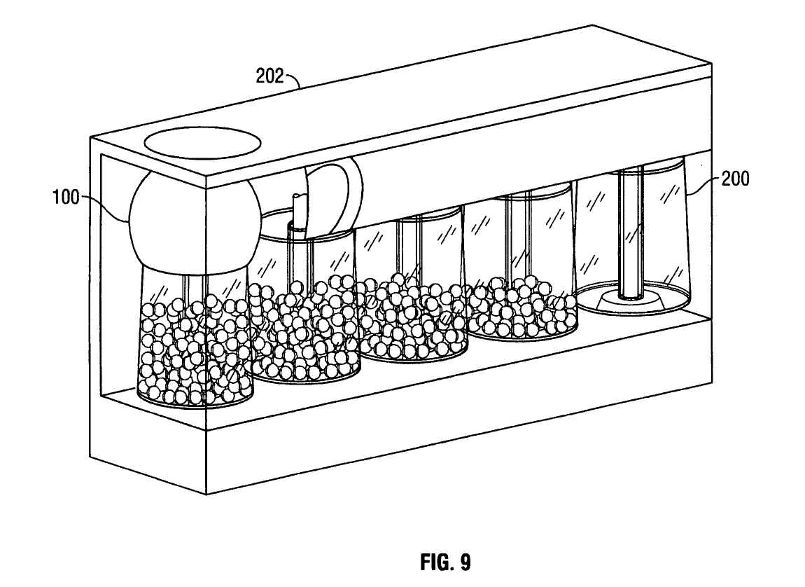

The interchangeable spice grinding assembly further includes multiple spice containers 200 in conjunction with a spice grinding assembly 100, as illustrated in FIG. 9. In one embodiment, a rack 202 may used to store the spice grinding assembly 100 and the spice containers 200. With multiple spice containers 200, the rack 202 readily stores multiple containers 200 typically having multiple types of spices, including various types of peppers. The spice grinding assembly 100 operates similar to the above discussion in FIGS. 1-8, thereby allowing for readily interchangeable spice dispensing using the single assembly 100.

Furthermore, while the particular preferred embodiments have been shown and described, it will be obvious to those skilled in the art that changes and modifications may be made without departing from the teaching of the invention. The matter set forth in the foregoing description and accompanying drawings is offered by way of illustration only and not as limitation. The actual scope of the invention is intended to be defined in the following claims when viewed in their proper perspective based on the related art.

What is claimed is:

1. A spice grinding assembly comprising:
a spice container having a spice holding portion and a dispensing portion;
a base member including a mill guide;
a central pole extending up from the base member such that the central pole extends through a central aperture of the spice container when the spice container contactingly engages the base member; and
a top affixable to the central pole and engaging the spice container such that rotation of the top rotates the central pole to rotate the mill guide and grind a spice disposed within the dispensing cavity.

2. The spice grinding assembly of claim 1 wherein the top further includes an engagement means interiorly disposed therein such that engagement means of the top contactingly engages the central pole.

3. The spice grinding assembly of claim 2 wherein the engagement means allows for the disengagement of the top with the central pole.

4. The spice grinding assembly of claim 1 wherein the dispensing cavity further includes a mill guide channel centrally disposed within the dispensing portion.

5. The spice grinding assembly of claim 4 wherein the mill guide channel includes multiple sloped surfaces for guiding the spice through a central aperture in the mill guide channel and a corresponding aperture in the dispensing portion.

6. The spice grinding assembly of claim 1 wherein the mill guide includes a centrally disposed raised section having at least one aperture having a cutting edge disposed on a portion of the aperture.

7. The spice grinding assembly of claim 1 wherein the base member includes an exterior portion having ridged edges.

8. The spice grinding assembly of claim 1 wherein rotation of the spice container aligns the spice container with the bottom portion member.

9. An interchangeable spice grinding assembly comprising:
a plurality of spice containers, wherein each of the plurality of spice containers include a spice holding portion, a dispensing portion and a central aperture;
a base member including a mill guide and bottom portion for engaging a first spice container from the plurality of spice containers;
a central pole extending up from the base member such that the central pole is extendable through the central aperture of the first spice container when the first spice container contactingly engages the bottom portion; and
a top affixable to the central pole and engaging the first spice container such that rotation of the top rotates the central pole to rotate the mill guide and grind a spice disposed within the dispensing portion of the first spice container.

10. The spice grinding assembly of claim 9 wherein the top further includes an engagement means interiorly disposed therein such that engagement means of the top contactingly engages the central pole.

11. The interchangeable spice grinding assembly of claim 10 wherein the engagement means allows for the disengagement of the top with the central pole.

12. The interchangeable spice grinding assembly of claim 9 wherein the dispensing portion for each of the plurality of spice containers further include a mill guide channel centrally disposed within the dispensing portion.

13. The interchangeable spice grinding assembly of claim 12 wherein the mill guide channel includes multiple sloped surfaces for guiding the spice through a central aperture in the mill guide channel and a corresponding aperture in the dispensing portion.

14. The interchangeable spice grinding assembly of claim 9 wherein the mill guide includes a centrally disposed raised section having at least on aperture having a cutting edge disposed on a portion of the aperture.

15. The interchangeable spice grinding assembly of claim 9 wherein the base member includes an exterior portion having ridged edges.

16. The interchangeable spice grinding assembly of claim 9 wherein rotation of the spice container aligns the spice container with the bottom portion.

17. The interchangeable spice grinding assembly of claim 9 wherein:
the engagement means disposed within the top is releasable from the central pole so that the top may be removed;
the first spice container may be removed from about the central pole after the top is removed;
a second spice container from the plurality of spice containers is disposed about the central pole such that the second spice container is aligned with the bottom portion; and
the top is releasable fitted to the central pole.

18. An interchangeable spice grinding assembly comprising:
a plurality of spice containers, wherein each of the plurality of spice containers include a spice holding portion, a dispensing cavity and a central aperture, the dispensing cavity for each of the plurality of spice containers further including a mill guide channel centrally disposed within the dispensing cavity;
a base member including a mill guide and bottom portion for engaging a first spice container from the plurality of spice containers, the mill guide channel includes multiple sloped surfaces for guiding the spice through a central aperture in the mill guide channel and a corresponding aperture in the dispensing cavity;
a central pole extending up from the base member such that the central pole is extendable through the central aperture of the first spice container when the first spice container contactingly engages the bottom portion; and
a top affixable to the central pole using an engagement means interiorly disposed within the top, the top engaging the first spice container such that rotation of the top rotates the central pole to rotate the mill guide and grind a spice disposed within the dispensing cavity of the first spice container.

19. The interchangeable spice grinding assembly of claim 18 wherein the mill guide includes a centrally disposed raised section having at least on aperture having a cutting edge disposed on a portion of the aperture.

20. The interchangeable spice grinding assembly of claim 18 further comprising:
the engagement means disposed within the top is releasable from the central pole;
the first spice container may be removed from about the central pole after the top is removed;
a second spice container from the plurality of spice containers is disposed about the central pole such that the second spice container is aligned with the bottom portion; and
the top is releasable fitted to the central pole.
